(19) United States
(12) Patent Application Publication
(10) Pub. No.: US 2008/0198510 A1
(43) Pub. Date: Aug. 21, 2008

(54) HEAD SLIDER AND STORAGE MEDIUM DRIVE

(75) Inventors: Masaharu Sugimoto, Kawasaki (JP); Takuya Kobayashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/029,276

(22) Filed: Feb. 11, 2008

(30) Foreign Application Priority Data
Feb. 15, 2007 (JP) 2007-034502

(51) Int. Cl. G11B 5/60

(52) U.S. Cl. 360/236.5

(57) ABSTRACT

A head slider arranged opposite to a storage medium, includes: a slider body, an insulating nonmagnetic layer laminated on a trailing edge of the slider body, and a head element embedded in the nonmagnetic film. A front edge of the head element is exposed at a top surface of the rail. A heater embedded in the nonmagnetic film near the head element, causes the head element to bulge at the top surface of the rail. A protection film is laminated on the top surface of the rail, and at least one protrusion is configured to protrude from a surface of the protection film and come close to the storage medium as compared with the top surface of the protection film when the head element bulges. The protrusion is used to determine how much to heat the film to bring the head element as close to the storage medium as possible.

### BACKGROUND

1. Field

The present technique relates to head sliders arranged in storage medium drives such as hard disk drives (HDDs), and more particularly to a head slider having a heater embedded in a nonmagnetic film corresponding to a head element.

2. Description of the Related Art

In a head slider, for example, a nonmagnetic film made of Al₂O₃ (alumina) is laminated on a slider body made of Al₂O₃—Tic (alumina-titanium carbide, AlTic). The nonmagnetic film has a head element and a heater embedded therein. The surface of the nonmagnetic film is covered with, for example, a protection film made of diamond like carbon (DLC). The head element is thus covered with the protection film.

The heater applies heat to a thin-film coil pattern provided in the head element. The thin-film coil pattern linearly expands accordingly, and hence, a read gap and a write gap of the head element can come close to a magnetic disk. A flying height of the head element is determined on the basis of a bulging amount of the thin-film coil pattern.

To determine the bulging amount, zero calibration is performed. Reference documents are Japanese Laid-open Patent Publication No. 2003-203321, Japanese translation of PCT international application Publication No. 2002-500798, Japanese Laid-open Patent Publication No. 2002-117509, Japanese Laid-open Patent Publication No. 05-20635, and US2005/0057841.

In the zero calibration process, the bulging amount of the thin-film coil pattern is gradually increased. When the protection film comes into contact with the magnetic disk, the bulging amount of the thin-film coil pattern is obtained. A most suitable bulging amount for reading and writing can be determined on the basis of the obtained bulging amount.

During the zero calibration process, the protection film comes into contact with the magnetic disk. As the contact is repeated, the protection film may be subjected to wear. The wear may reduce the thickness of the protection film. As a result, the protection film can no longer effectively protect the head element. For example, the head element may be subjected to corrosion under a high temperature and humidity environment. The characteristics of the head element may be deteriorated.

The present technique is provided in light of the situations described above, and an object of the technique is to provide a head slider and a storage medium drive capable of preventing a head element from being damaged in this manner.

### SUMMARY

The disclosed technique was produced for solving the problems due to the foregoing related techniques. A head slider arranged opposite to a storage medium has a slider body, an insulating nonmagnetic layer laminated on a trailing edge of the slider body, and a rail formed on a medium-opposing surface of the slider body and extending from the slider body to the nonmagnetic film. A head element is embedded in the nonmagnetic film, a front edge of the head element being exposed at a top surface of the rail. A heater is embedded in the nonmagnetic film, the heater causing the head element to bulge at the top surface of the rail. A protection film is laminated on the top surface of the rail, and a protrusion is configured to protrude from a surface of the protection film and come closer to the storage medium than the top surface of the protection film when the head element bulges.

### BRIEF DESCRIPTION OF THE DRAWINGS

FIG. 1 is a plan view schematically showing the inner structure of a hard disk drive, which is a storage medium drive according to an embodiment of the present technique.

FIG. 2 is a perspective view schematically showing the structure of a flying head slider arranged in the storage medium drive.

FIG. 3 is a partially-enlarged perspective view schematically showing the structure of a rear rail.

FIG. 4 is a partially-enlarged cross-sectional view schematically showing the structure of the rear rail.

FIG. 5 is a front elevation view schematically showing the structure of an electromagnetic conversion element mounted on the flying head slider.

FIG. 6 is an enlarged cross-sectional view taken along the line VI-VI in FIG. 5.

FIG. 7 is an enlarged cross-sectional view taken along the line VII-VII in FIG. 6.

FIG. 8 is a cross-sectional view of the rear rail for schematically showing “a bulge” formed at the flying head slider.

FIG. 9 is a rear elevation of the rear rail for schematically showing “the bulge” formed at the flying head slider.

FIG. 10 is a block diagram showing a control system of the hard disk drive relating to a heating wire, and the electromagnetic conversion element mounted on the flying head slider.

FIG. 11 is a cross-sectional view schematically showing a state where protrusions come into contact with a magnetic disk.

FIG. 12 is a rear elevation schematically showing the state where the protrusions come into contact with the magnetic disk.

FIG. 13 is an enlarged cross-sectional view schematically showing the structure of a heating wire according to another embodiment.

FIG. 14 is a rear elevation schematically showing a state where protrusions come into contact with a magnetic disk.

FIG. 15 is a cross-sectional view schematically showing first and second regions of a nonmagnetic film.

### DESCRIPTION OF THE PREFERRED EMBODIMENTS

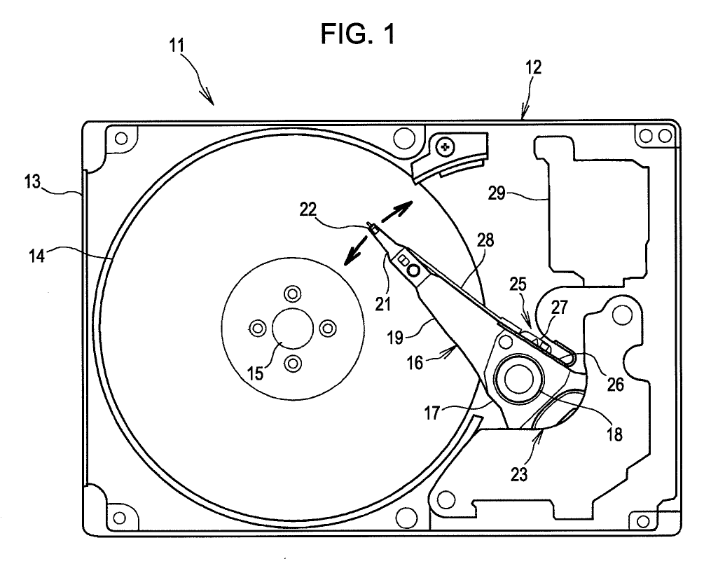

FIG. 1 schematically shows the inner structure of a hard disk drive (HDD) (storage medium drive) 11 according to an embodiment of the present technique. The hard disk drive 11 includes a housing (case) 12. The housing 12 has a box-like base 13 and a cover (not shown). The base 13 defines, for example, a flat rectangular-parallelepiped inner space, or housing space. The base 13 may be formed by casting using a metal material such as aluminum. The cover is coupled to the opening of the base 13. The housing space is sealed with the cover and the base 13. The cover may be formed, for example, by pressing using a plate member.

The housing space houses at least a magnetic disk 14 as a storage medium. The magnetic disk 14 is mounted to a rotating shaft of a spindle motor 15. The spindle motor 15 can rotate the magnetic disk 14 at a high speed of, for example, 5400, 7200, 10000, or 15000 rpm. The magnetic disk 14 is a perpendicular recording magnetic storage medium.

The housing space further houses a carriage 16. The carriage 16 has a carriage block 17. The carriage block 17 is rotatably coupled to a vertically extending spindle 18. The carriage block 17 has a plurality of carriage arms 19 horizontally extending from the spindle 18. The carriage block 17 may be molded, for example, by extrusion using aluminum.

A head suspension 21 is attached to the tip end of each of the carriage arms 19. The head suspension 21 extends from the tip end of the carriage arm 19 to the front. A flexure is bonded to the tip end of the head suspension 21. The flexure has a gimbal spring. As the gimbal spring works, a flying head slider 22 can change its posture relative to the head suspension 21. Though described below, an electromagnetic conversion element (head element) is mounted to the flying head slider 22.

When an airflow is generated at the surface of the magnetic disk 14 due to the rotation of the magnetic disk 14, a positive pressure, or a buoyant force, and a negative pressure act on the flying head slider 22 because of the effect of the airflow. The buoyant force and the negative pressure are balanced with a pressing force of the head suspension 21, whereby the flying head slider 22 can continuously fly with a relatively high rigidity during the rotation of the magnetic disk 14.

If the carriage 16 rotates around the spindle 18 while the flying head slider 22 flies, the flying head slider 22 can move along a radial line of the magnetic disk 14. As a result, the electromagnetic conversion element mounted on the flying head slider 22 can move across a data zone between the innermost recording track and the outermost recording track. The electromagnetic conversion element on the flying head slider 22 can be positioned at a desired recording track.

The carriage block 17 is connected to a power source such as a voice coil motor (VCM) 23. As the VCM 23 works, the carriage block 17 can rotate around the spindle 18. The carriage arm 19 and the head suspension 21 can swing in accordance with the rotation of the carriage block 17.

As shown in FIG. 1, a flexible printed circuit board unit 25 is disposed on the carriage block 17. The flexible printed circuit board unit 25 has a head IC (integrated circuit) 27 that is mounted on a flexible printed circuit board 26. The head IC 27 is connected to a read head element and a write head element of the electromagnetic conversion element. A flexible printed circuit board 28 is used for the connection. The flexible printed circuit board 28 extends from each of the flexures. The flexible printed circuit board 28 is connected to the flexible printed circuit board unit 25.

For reading of magnetic information, sense current is supplied from the head IC 27 to the read head element of the electromagnetic conversion element. The read head element employs, for example, a current-perpendicular-to-plane (CPP) read head element. For writing of magnetic information, write current is supplied from the head IC 27 to the write head element of the electromagnetic conversion element. The write head element employs, for example, a single pole head element. The current value of the sense current is determined to a given value. The current is supplied to the head IC 27 from a small circuit board 29 disposed in the housing space, and a printed circuit board (not shown) attached to the back side of a bottom plate of the base 13.

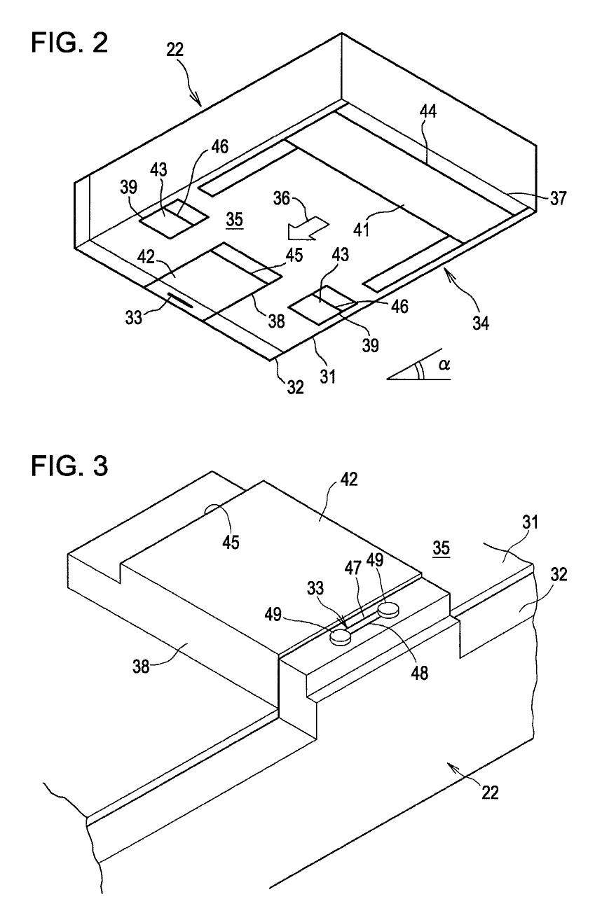

FIG. 2 shows the flying head slider 22 according to an embodiment. The flying head slider 22 has, for example, a flat rectangular-parallelepiped slider body 31. An element-containing film (nonmagnetic layer) 32 is laminated on a trailing edge of the slider body 31. The above-described electromagnetic conversion element 33 is arranged in the element-containing film 32. The details of the electromagnetic conversion element 33 will be described later. The slider body 31 may be made of a hard, nonmagnetic material, such as Al₂O₃—Tic (alumina-titanium carbide, AlTic). The element-containing film 32 may be made of a relatively soft, insulating nonmagnetic material, such as Al₂O₃ (alumina).

A medium-opposing surface, or an air bearing surface 34 of the flying head slider 22 faces the magnetic disk 14. The air bearing surface 34 has a flat base surface 35 serving as a reference plane. As the magnetic disk 14 rotates, an airflow 36 acts on the air bearing surface 34 from the front edge to the rear edge of the slider body 31.

A front rail 37 is formed at the air bearing surface 34. The front rail 37 projects from the base surface 35 near the upstream side, or the leading side of the airflow 36. The front rail 37 extends in a slider width direction along the leading edge of the base surface 35. Also, a rear rail 38 is formed at the air bearing surface 34. The rear rail 38 projects from the base surface 35 near the downstream side, or the trailing side of the airflow 36. The rear rail 38 is arranged at the center in the slider width direction. The rear rail 38 extends from the slider body 31 to the element-containing film 32.

Further, a pair of auxiliary rear rails 39 are formed at the air bearing surface 34. The auxiliary rear rails 39 project from the base surface 35 near the trailing side. The auxiliary rear rails 39 are arranged respectively along left and right edges of the base surface 35. Hence, the auxiliary rear rails 39 are arranged with an interval provided therebetween in the slider width direction. The rear rail 38 is arranged between the auxiliary rear rails 39.

The front rail 37, the rear rail 38, and the auxiliary rear rails 39 have air bearing surfaces (ABS) 41, 42, and 43 at their top surfaces. Leading edges of the air bearing surfaces 41, 42, and 43 are connected to the top surfaces of the rails 37, 38, and 39 through steps 44, 45, and 46. The air bearing surface 34 receives the airflow 36 generated due to the rotation of the magnetic disk 14. At this time, relatively large positive pressures, or buoyant forces are generated at the air bearing surfaces 41, 42, and 43 because of the effects of the steps 44, 45, and 46. Also, a large negative pressure is generated at the rear, or the back of the front rail 37. Accordingly, the flying posture of the flying head slider 22 is determined on the basis of the balance between the buoyant forces and the negative pressure. The configuration of the flying head slider 22 is not limited to the one described above.

On the air bearing surfaces 41, 42, and 43, for example, protection films (not shown) are laminated. The top surface of the rear rail 38 is covered with the protection film at the trailing edge of the air bearing surface 42. As shown in FIG. 3, the electromagnetic conversion element 33 extends in the slider width direction. The electromagnetic conversion element 33 allows the front edge of a CPP read head element 47 and a front edge of the single pole head element 48 to be exposed at the top surface of the rear rail 38. The protection film has a pair of protection pads (protrusions) 49 vertically arranged on the surface thereof. The protection pads 49 are disposed on both left and right sides of the electromagnetic conversion element 33 in the slider width direction. That is, the protection pads 49 are disposed parallel to the trailing edge of the slider body 31 with a predetermined interval provided between the protection pads 49.

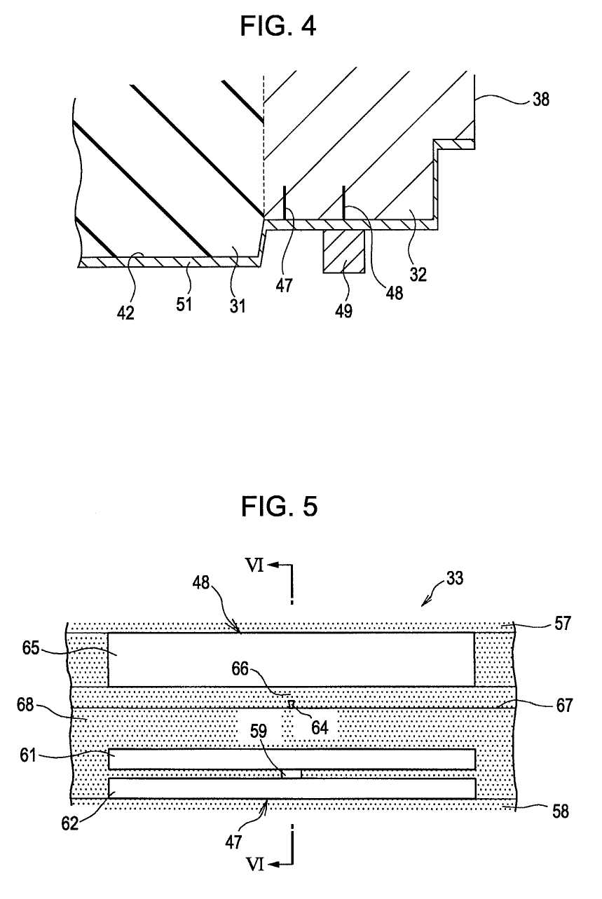

Also referring to FIG. 4, a protection film 51 is laminated on the front edge of the CPP read head element 47 and the front edge of the single pole head element 48. The protection pads 49 are disposed, for example, on both sides of the single pole head element 48 in the slider width direction. The protection film 51 and the protection pads 49 may be made of, for example, diamond like carbon (DLC).

FIG. 5 shows the details of the structure of the electromagnetic conversion element 33. The CPP read head element 47, as is well known, can detect binary data on the basis of a resistance variable according to the magnetic field applied by the magnetic disk 14. The single pole head element 48 can write binary data on the magnetic disk 14 by using a magnetic field produced by, for example, a thin-film coil pattern (described later). The CPP read head element 47 and the single pole head element 48 are interposed between Al₂O₃ films 57 and 58. The Al₂O₃ film 57 serves as an upper half layer, or overcoat film of the element-containing film 32. The Al₂O₃ film 58 serves as a lower half layer, or undercoat film of the element-containing film 32.

The CPP read head element 47 has a magnetoresistive film 59 such as a spin-valve film or a tunnel junction film. The magnetoresistive film 59 is interposed between an upper electrode 61 and a lower electrode 62. The upper and lower electrodes 61 and 62 are respectively in contact with the upper and lower boundaries of the magnetoresistive film 59 at the front edge where the upper and lower electrodes 61 and 62 are exposed at the surface of the slider body 31. The upper and lower electrodes 61 and 62 supply the magnetoresistive film 59 with sense current. The upper and lower electrodes 61 and 62 may have a conductivity, and a soft magnetic property. If the upper and lower electrodes 61 and 62 are made of a conductive and soft magnetic material such as a permalloy (Ni—Fe alloy), the upper and lower electrodes 61 and 62 can also serve as upper and lower shield layers of the CPP read head element 47. In this way, the upper and lower electrodes 62 define a read gap.

The single pole head element 48 has a main pole 64 and an auxiliary pole 65 both being exposed at the air bearing surface 42. The main pole 64 and the auxiliary pole 65 may be made of a conductive soft magnetic material such as a permalloy. The main pole 64 and the auxiliary pole 65 together define a magnetic core of the single pole head element 48. For example, a nonmagnetic gap layer 66 made of Al₂O₃ is interposed between the main pole 64 and the auxiliary pole 65. When a magnetic field is produced by the thin-film coil pattern (described below), with the effect of the nonmagnetic gap layer 66, the magnetic flux leaks from the main pole 64 to the auxiliary pole 65. The leaking magnetic flux forms a gap magnetic field, or a recording magnetic field. In this way, the main pole 64 and the auxiliary pole 65 define a write gap.

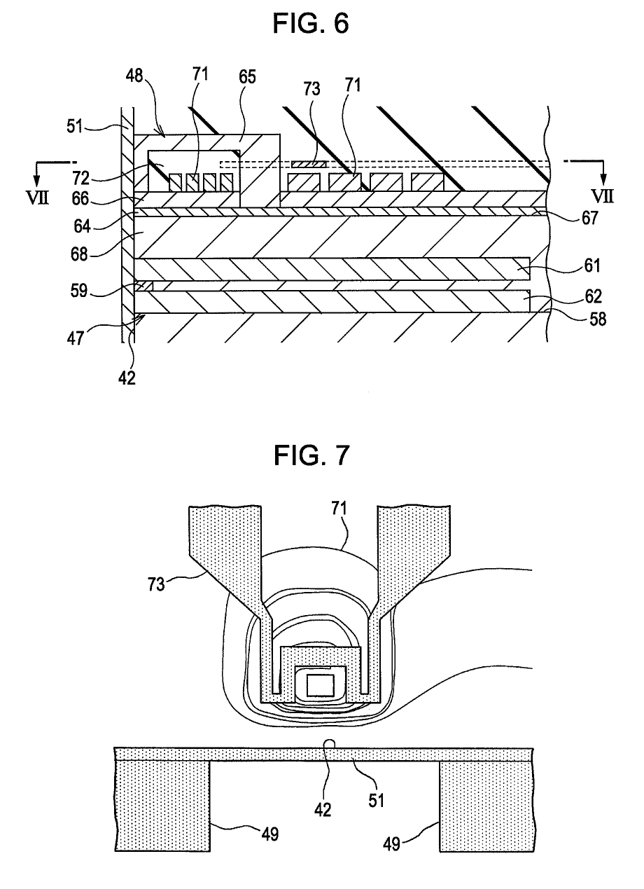

Also referring to FIG. 6, the main pole 64 extends along a given reference plane 67 located above the upper electrode 61. The reference plane 67 is defined by the surface of a nonmagnetic layer 68 made of Al₂O₃. The nonmagnetic layer 68 may be laminated on the upper electrode 61 with a uniform thickness. The nonmagnetic layer 68 prevents the upper electrode 61 from being magnetically connected to the main pole 64.

A thin-film coil pattern 71 is disposed on the nonmagnetic gap layer 66. The thin-film coil pattern 71 extends along a plane in a spiral manner. The thin-film coil pattern 71 is embedded in an insulating layer 72 above the nonmagnetic gap layer 66. The above-described auxiliary pole 65 is formed on the surface of the insulating layer 72. The auxiliary pole 65 is magnetically coupled to the main pole 64 at the center of the thin-film coil pattern 71. When current is supplied to the thin-film coil pattern 71, magnetic flux circulates through the main pole 64 and the auxiliary pole 65.

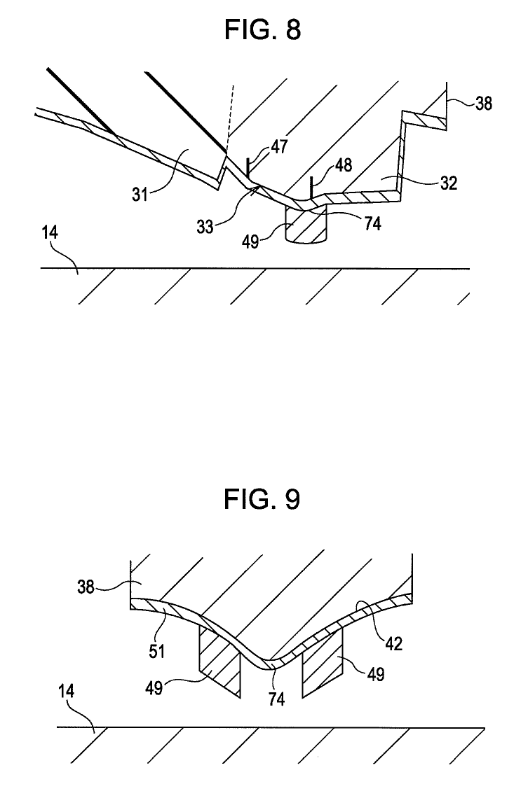

The element-containing film 32 has a heater arranged therein corresponding to the electromagnetic conversion element 33. The heater is, for example, a heating wire 73 embedded in the insulating layer 72. The heating wire 73 extends along a plane. As shown in FIG. 7, the heating wire 73 extends so as not to pass through the center of the thin-film coil pattern 71. The thin-film coil pattern 71 has a relatively large coefficient of linear expansion, and hence, when electric power is supplied to the heating wire 73, the heating wire 73 generates heat, whereby the thin-film coil pattern 71 expands due to the heat. Then, as shown in FIG. 8, the thin-film coil pattern 71, that is, the single pole head element 48 bulges at the surface of the element-containing film 32, or at the top surface of the rear rail 38. A bulge 74 is formed accordingly. In this way, the CPP read head element 47 and the single pole head element 48 are displaced toward the magnetic disk 14. For example, a flying height of the single pole head element 48 is determined in accordance with a bulging amount of the single pole head element 48. At this time, the protection pads 49 are located on both sides of the top of the bulge 74 as shown in FIG. 9. The top of the bulge 74 is located at the top surface of the protection film 51. The protection pads 49 always come close to the magnetic disk 14 as compared with the top surface of the protection film 51.

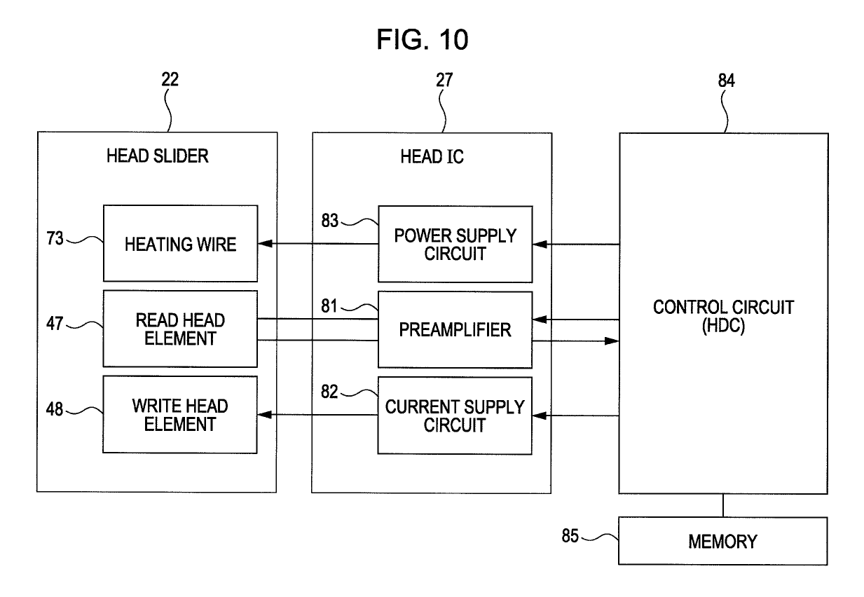

As shown in FIG. 10, the head IC 27 has a preamplifier circuit 81, a current supply circuit 82, and a power supply circuit 83. The preamplifier circuit 81 is connected to the CPP read head element 47. Sense current is supplied from the preamplifier circuit 81 to the CPP read head element 47. The current value of the sense current is held at a predetermined value.

The current supply circuit 82 is connected to the single pole head element 48. Write current is supplied from the current supply circuit 82 to the single pole head element 48. The single pole head element 48 generates a magnetic field on the basis of the supplied write current.

The power supply circuit 83 is connected to the heating wire 73. Electric power is supplied from the power supply circuit 83 to the heating wire 73. The heating wire 73 generates heat in accordance with the supplied electric power. The temperature of the heating wire 73 is determined by the electric energy. That is, the bulging amount of the bulge 74 can be controlled on the basis of the electric energy.

The head IC 27 is connected to a control circuit (hard disk controller, HDC) 84. The control circuit 84 instructs the head IC 27 to supply the sense current, write current, and electric power. In addition, the control circuit 84 detects the voltage of the sense current. Before the detection of the voltage, the preamplifier circuit 81 amplifies the voltage of the sense current.

The control circuit 84 determines the binary data on the basis of the output of the preamplifier circuit 81. Further, the control circuit 84 detects “a fluctuation” of the voltage value on the basis of the output of the preamplifier circuit 81. For example, when the protection pads 49 come into contact with the magnetic disk 14 on account of the formation of the bulge 74, the flying head slider 22 may be slightly vibrated. At this time, “a fluctuation” is generated in the voltage value of the sense current. The control circuit 84 detects “the fluctuation”.

The control circuit 84 controls the operations of the preamplifier circuit 81, the current supply circuit 82, and the power supply circuit 83 corresponding to a predetermined software program. Such a software program may be stored in, for example, a memory 85. With the software program, zero calibration (described later) is performed. Data required for the zero calibration may be also stored in the memory 85. The software program and data may be transmitted to the memory 85 from other storage medium. The control circuit 84 and the memory 85 may be mounted on the circuit board 29.

In this hard disk drive 11, the bulging amount of the single pole head element 48 is determined before reading or writing of magnetic information. To determine the bulging amount, zero calibration is performed. During the zero calibration, the bulging amount of the bulge 74 is measured when the protection pads 49 come into contact with the magnetic disk 14. A bulging amount of the bulge 74 for reading or writing of information is determined on the basis of the measured bulging amount in the contact state. The bulging amount of the bulge 74 for reading or writing of information is determined, whereby the single pole head element (electromagnetic conversion element) 48 can fly over the surface of the magnetic disk 14 at a predetermined flying height. The zero calibration may be performed, for example, every time when the hard disk drive 11 is activated.

To perform the zero calibration, the control circuit 84 executes the predetermined software program. When the software program is executed, the control circuit 84 performs initial setting of the hard disk drive 11. In the initial setting, the control circuit 84 instructs the spindle motor 15 to drive. The magnetic disk 14 rotates at a predetermined rotation speed accordingly. Also, the control circuit 84 instructs the VCM 23 to drive. The carriage 16 swings around the spindle 18 accordingly. As a result, the flying head slider 22 faces the surface of the magnetic disk 14. The flying head slider 22 flies over the magnetic disk 14 at a predetermined flying height. Further, the control circuit 84 supplies the head IC 27 with current. The control circuit 84 monitors the output of the preamplifier circuit 81. That is, the control circuit 84 observes the voltage value of the sense current. At this time, the power supply circuit 83 suspends the supplement of the electric power.

When the initial setting is completed, the control circuit 84 supplies the power supply circuit 83 with a command signal. The control circuit 84 increases the bulging amount of the bulge 74 by a given increment. In response to the reception of the command signal, the power supply circuit 83 supplies the heating wire 73 with electric power of an electric energy corresponding to the increased bulging amount. The given increment may be, for example, 0.1 nm. The electric energy may be determined in advance on the basis of the coefficient of linear expansion of the single pole head element 48. When the bulging amount of the bulge 74 is increased, the control circuit 84 determines “contact” between the protection pads 49 and the magnetic disk 14. For the judgment, the control circuit 84 observes the presence of “a fluctuation” appearing in the voltage value of the sense current.

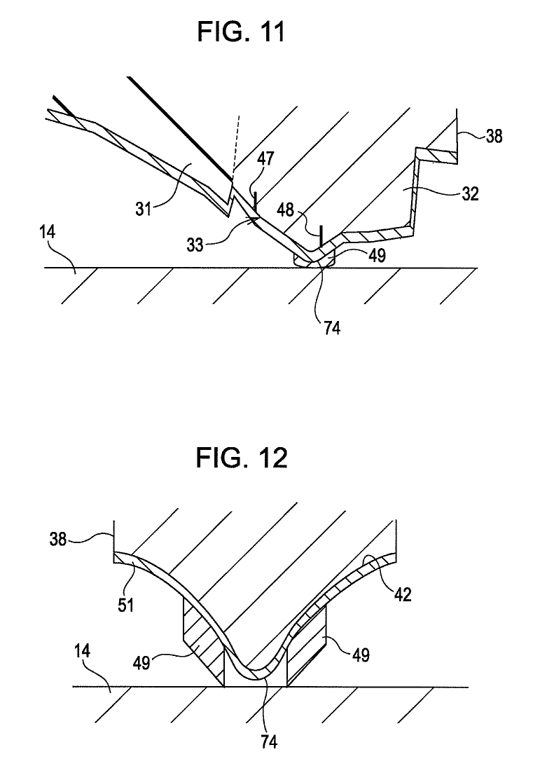

The control circuit 84 increases the bulging amount of the bulge 74 by the given increment until the control circuit 84 observes “the fluctuation”. The protection pads 49 always come close to the magnetic disk 14 as compared with the top of the bulge 74, in accordance with the bulging amount of the bulge 74. Finally, as shown in FIG. 11, the protection pads 49 come into contact with the magnetic disk 14. Also referring to FIG. 12, the bulge 74, or the top surface of the protection film 51 can be prevented from coming into contact with the magnetic disk 14, in an area between the protection pads 49. Thus, “the fluctuation” is observed. The control circuit 84 determines the contact between the protection pads 49 and the magnetic disk 14. The control circuit 84 then determines the bulging amount of the bulge 74. Thus, the bulging amount in the contact state can be obtained. The obtained bulging amount is stored in, for example, the memory 85. It should be noted that a predetermined distance is provided between the tip ends of the protection pads 49 and the top of the bulge 74 in the contact state. The distance is referenced when the flying height of the single pole head element 48 is determined. The distance may be calculated in advance, for example, on the basis of a simulation. The zero calibration is thus completed.

In the above-described hard disk drive 11, the protection pads 49 come into contact with the magnetic disk 14 when the bulging amount of the bulge 74 is determined. The top surface of the protection film 51 can be prevented from coming into contact with the magnetic disk 14 in the area between the protection pads 49. Thus, wear of the protection film 51 can be reliably prevented at the top of the bulge 74. The protection film 51 can effectively protect the electromagnetic conversion element 33. Thus, corrosion of the electromagnetic conversion element 33 can be reliably prevented.

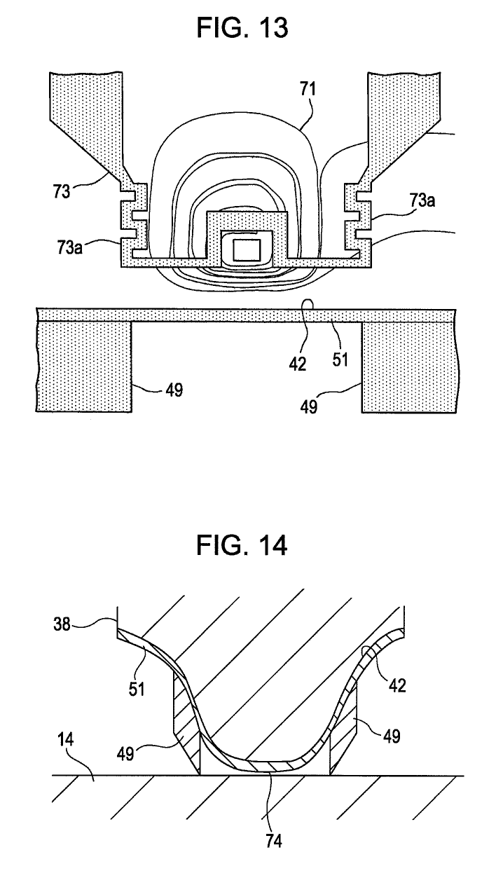

As shown in FIG. 13, the width of the heating wire 73 may be increased in the flying head slider 22. The heating wire 73 defines meander regions 73a that extend in a meandering manner. The meander regions 73a are disposed on both sides of the thin-film coil pattern 71, or the single pole head element 48. Since the meander regions 73a extend in the meander manner, the heating wire 73 can have a sufficient length on both sides of the thin-film coil pattern 71. With this heating wire 73, as shown in FIG. 14, a bulge 74 expands in the width direction of the electromagnetic conversion element 33. Accordingly, the interval between the protection pads 49 is increased. The protection pads 49 can come into contact with the magnetic disk 14 stably.

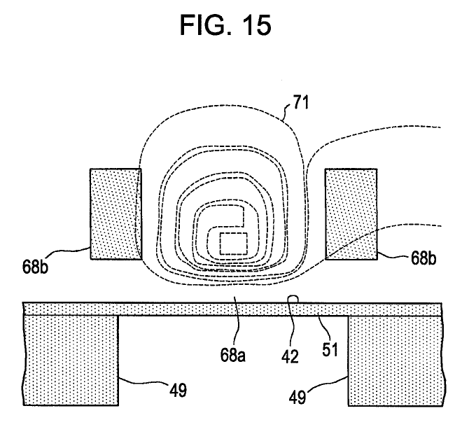

As shown in FIG. 15, the nonmagnetic layer 68 has, for example, a first region 68a and second regions 68b. A coefficient of linear expansion of the second regions 68b is larger than a coefficient of linear expansion of the first region 68a. The second regions 68b may be located at positions corresponding to the meander regions 73a of the heating wire 73. In particular, the second regions 68b may be disposed on both sides of the electromagnetic conversion element 33. The second regions 68b may be made of a nonmagnetic material such as Cu. With the effects of the second regions 68b, the expansion of the bulge 74 in the width direction can be promoted. Since the interval between the protection pads 49 is increased like the case described above, the protection pads 49 can come into contact with the magnetic disk 14 stably.

With the above-described flying head slider 22, the protection pads 49 do not have to be disposed parallel to the trailing edge of the slider body 31. For example, one of the protection pads 49 may be disposed near the leading edge, and the other one may be disposed near the trailing edge. Otherwise, the protection pads 49 may be replaced with a protruding wall continuously surrounding the periphery of the bulge 74. In this case, the protruding wall may have a notch. The shape of the protection pad 49 is not limited to those described above. The shape of the protection pad 49 may be modified as desired.

With the above-described configuration of the present technique, the protrusions come close to the storage medium as compared with the top surface of the protection film when the head element bulges. Accordingly, the top surface of the protection film can be reliably prevented from coming into contact with the storage medium when the protrusions come into contact with the storage medium. Wear of the protection film can be prevented at the front edge of the head element. Damage of the head element can be thus effectively prevented.

In addition, since the pair of protrusions are provided on the surface of the protection film, and the protrusions are disposed parallel to the trailing edge of the slider body with the predetermined interval provided between the protrusions, the pair of protrusions can come into contact with the storage medium stably.

Further, since the nonmagnetic film has the first region with the first coefficient of linear expansion, and the second regions with the second coefficient of linear expansion which is larger than the first coefficient of linear expansion, the second regions being provided on both sides of the head element, the width of the bulge of the head element is increased by the effects of the heater and the second regions. The interval between the protection pads is increased. Thus, the protection pads can come into contact with the storage medium stably.

With the present technique, the head slider and the storage medium drive capable of preventing the head element from being damaged can be provided.

What is claimed is:

1. A head slider arranged opposite to a storage medium, comprising:
a slider body;
an insulating nonmagnetic film laminated on a trailing edge of the slider body;
a rail formed on a medium-opposing surface of the slider body and extending from the slider body to the nonmagnetic film;
a head element embedded in the nonmagnetic film, a front edge of the head element being exposed at a top surface of the rail;
a heater embedded in the nonmagnetic film near the head element, the heater causing the head element to bulge at the top surface of the rail;
a protection film laminated on the top surface of the rail; and
a protrusion configured to protrude from a surface of the protection film and come close to the storage medium as compared with the top surface of the protection film when the head element bulges.

2. The head slider according to claim 1,
wherein the protrusion includes a pair of protrusions disposed parallel to the trailing edge of the slider body with a predetermined interval provided between the protrusions.

3. The head slider according to claim 2,
wherein the head element includes a write head element, and the protrusions are disposed on both sides of the write head element.

4. The head slider according to claim 2,
wherein the heater is arranged on both sides of the head element.

5. The head slider according to claim 2,
wherein the nonmagnetic film includes a first region with a first coefficient of linear expansion, and second regions with a second coefficient of linear expansion larger than the first coefficient of linear expansion, the second regions being provided on both sides of the head element.

6. The head slider according to claim 1,
wherein the protrusion includes a plurality of protrusions disposed on both sides of a top of the head element, the top being defined when the head element bulges.

7. A storage medium drive comprising at least a head slider arranged opposite to a storage medium,
wherein the head slider includes:
a slider body,
an insulating nonmagnetic film laminated on a trailing edge of the slider body,
a rail formed on a medium-opposing surface of the slider body and extending from the slider body to the nonmagnetic film,
a head element embedded in the nonmagnetic film, a front edge of the head element being exposed at a top surface of the rail,
a heater embedded in the nonmagnetic film corresponding to the head element, the heater causing the head element to bulge at the top surface of the rail,
a protection film laminated on the top surface of the rail, and
a protrusion configured to protrude from a surface of the protection film and come close to the storage medium as compared with the top surface of the protection film when the head element bulges.

8. The storage medium drive according to claim 7,
wherein the protrusion includes a pair of protrusions disposed parallel to the trailing edge of the slider body with a predetermined interval provided between the protrusions.

9. The storage medium drive according to claim 8,
wherein the head element includes a write head element, and the protrusions are disposed on both sides of the write head element.

10. The storage medium drive according to claim 8,
wherein the heater is arranged on both sides of the head element.

11. The storage medium drive according to claim 8,
wherein the nonmagnetic film includes a first region with a first coefficient of linear expansion, and second regions with a second coefficient of linear expansion larger than the first coefficient of linear expansion, the second regions being provided on both sides of the head element.

12. The storage medium drive according to claim 7,
wherein the protrusion includes a plurality of protrusions disposed on both sides of a top of the head element, the top being defined when the head element bulges.
